(19) United States
(12) Patent Application Publication
(10) Pub. No.: US 2002/0016755 A1
(43) Pub. Date: Feb. 7, 2002

(54) Method of establishing a commercial relationship between a service provider and a potential customer of the service, including a reasoning criterion, and method of face-to-face advertising in a public place

(76) Inventor: Kenneth F. Pearce, Danville, KY (US)

Correspondence Address: Kenneth F. Pearce, 631 Denmark Drive, Danville, KY, 40422-2419, US

(21) Appl. No.: 09/900,605

(22) Filed: Jul. 9, 2001

Related U.S. Application Data
(60) Provisional application No. 60/219,139, filed on Jul. 17, 2000.

(51) Int. Cl. G06F 17/60

(52) U.S. Cl. 705/35

(57) ABSTRACT

Methods for establishing commercial relationships between the consumer of the service and the service provider including the articulation of a reasoning criterion, and methods of publicly displaying messages utilizing unique headdress. The reasoning criterion illustrates, illuminates and educates the potential consumer regarding the services of the provider while the headdress worn publicly can be fitted with either manual or electronic message boards.

A unique blending or intermingling of universally recognized real or virtual images or both with a recognized language originates the reasoning criterion. Additionally, a bi-directional intercommunication channel between the potential consumer and the service provider is established. The intercommunication is accomplished by using face-to-face, electronic or World Wide Web embodiments.

This Application for Letters Patent relates back to Provisional Application, Ser. No. 60/219,139, Pearce, Kenneth F., filed Jul. 17, 2000 that was entitled—METHOD OF ESTABLISHING A COMMERCIAL RELATIONSHIP BETWEEN A SERVICE PROVIDER AND A POTENTIAL CONSUMER OF THE SERVICE, INCLUDING A REASONING CRITERION—on the date the Provisional Application was filed.

### BACKGROUND OF THE INVENTION

1. Field of the Invention

A method for establishing a commercial relationship between the consumer of the service and the service provider. One embodiment of the present method articulates a reasoning criterion that illustrates, illuminates as well educates the potential consumer regarding the services of the provider. Within the scope of the present invention, a unique blending or intermingling of real or virtual images or both with language originate the reasoning criterion. Generally, without regard to the potential consumer's native tongue, easily recognizable or universal images are included in the reasoning criterion.

In accordance with one embodiment of the present invention, there is bi-directional intercommunication between the potential consumer and the service provider. The intercommunication can be face-to-face or electronic via televised or broadcast media, as well as over the World Wide Web. One or more embodiments of the present invention can also include a professional paradigm. Additionally, the service provider's Trademark or Service Mark, in whole or in part, can be incorporated into the language of the present invention. Moreover, while articulation of the present criterion and its accompanying method tacitly suggest the potential consumer utilize the provider's service, such articulation also tends to segregate the staid from the frivolous potential consumer.

Another embodiment of the present invention incorporates a unique headdress and an advertising or other message into a method of exposing the advertising or other message in public places. Manual and electronic message boards are compatible with the present method. The electronic message boards can be preprogrammed with predetermined messages or they can be controlled via radio frequency from locations remote from the headdress. Select embodiments of the present method also incorporate registered Trademarks and/or Service Marks into the messages or advertisements. And in one unique embodiment of the present method, a cubic-like headdress is utilized.

2. Description of the Previous Art

a) U.S. Pat. No. 6,026,377-Burke enables a system that generates an image representative of a store shelf holding multiple product packages. This image is displayed on the consumer's television. By utilizing a specific television input device, the consumer can zoom in or our, pan left or right or rotate the product responsive to the consumer's desire.

b) U.S. Pat. No. 5,740,549-Reilly, et. al. discloses an information and advertising distribution system. The Reilly system is dedicated solely to supplying predetermined information, news and advertising to and on the screen saver of the receiving computer. Additionally, the '549 system does not teach bidirectional intercommunication between the advertiser and the personal computer.

c) U.S. Pat. No. 6,014,634-Scroggie, et. al. teaches a system and method for the distribution, via a computer network, of incentives and shopping aids useful to customers. The incentives can only be redeemed at specific retailers. Selected steps of the Scroggie method include, the customer logging into the computer network, transmission of the incentive offers to the registered customer, and the exercising the offers in the customer's geographic region at retailers designated to accept the incentives.

d) U.S. Pat. No. 5,743,745-Reintjes discloses a device for playing back short films and/or advertising spots and/or quiz questions and/or answers. The '745 patent is directed toward regional or supra-regional advertising. And the Reintjes invention is intended to be installed in stores, entertainment centers or other establishments providing food, drink or entertainment.

e) U.S. Pat. No. 4,706,960-Nowacki, et. al. discloses a combined card and board game. The invention consists of over 205 fields of law, legal categories and legal process as well as legal terminology. According to the '960 specification, the game is intended to stimulate graduation from law school and the passing of the bar examination. Thus, due to the subject matter and the complicated rules of the game, the market for the Nowacki game would be very limited, i.e., something not readily comprehended by those untrained in the law.

f) U.S. Pat. No. 4,706,960-Vail enables a board, dice and card game. The game intends to entertain the participants as well as instruct them in the principals of criminal and Constitutional law and procedure. In the end, it is hoped the participant will be more aware of the citizen's rights and responsibilities in a lawful and free society.

### SUMMARY OF TUE INVENTION

Unlike traditional broadcast media advertising, select embodiments of the present invention relates to methods of establishing commercial relationships between service providers and consumers of the service through the use of bi-directional communication channels between service providers and potential consumers. Other embodiments of the invention utilize a unique headdress in public places to display messages. Whether face-to-face, or via electronic transmissions, such as television or over the World Wide Web, there is the high probability of active intercommunication between service providers and potential consumers. And depending upon the needs of the potential consumer, the time spent in active intercommunication between the potential consumer and the service provider can range from between a few seconds to several hours or more.

Within the scope of the present invention, service providers originate reasoning criterions dedicated to articulating the services offered. In accordance with the present methods, various reasoning criterions not only illustrate and illuminate but they can also educate and/or explain the services offered by the provider. Reasoning criterions utilized with the present methods are as diverse as the types of services offered. In other words, within the ambit of the present invention, it is believed any service provider can incorporate these inventive methods into their business plans. At the same time, the majority of embodiments disclosed more fully hereinafter are targeted toward potential consumers of legal services. Specifically, potential consumers of legal services related to the intellectual property disciplines of patents, trademarks and copyrights. However, and as previously set forth, the present method of establishing a commercial relationship between the potential consumer and the service provider can be utilized by any service provider, from accompanists to zigzaggers.

Universal or easily recognizable images, regardless of the native tongue of the potential consumer, are frequently incorporated into the reasoning criterions. Unique to select embodiments of the present methods of establishing commercial relationships is the coupling of at least one real or virtual image with language. It is the intermingling or merging of language and images (real, virtual, electronic, etc.) which creates reasoning criterions, within the scope of the present invention. Moreover, the service provider's Registered Trademark or Service Mark, as well as the words or symbols that are part of the Registered Marks can also be incorporated into the reasoning criterions.

In another embodiment of the present invention, a unique headdress having at least one message board is displayed in a public place. Messages depicted by the message board can be altered manually or electronically. And as with other embodiments of the present invention, a Registered Trademark or Service Mark can be incorporated into the message that is frequently an advertisement sponsored by the owner of the Registered Mark.

An object of the present invention is to provide a method of opening a communication channel between the service provider and the potential consumer of the service wherein the subsequent intercommunication is bi-directional.

It is another object of the present invention to enable the establishment of a commercial relationship between the consumer and the service provider subsequent to their initial intercommunication.

Still another object of the present invention is to provide an intercommunication incorporating a reasoning criterion originated and articulated by the service provider.

Yet another object of the present invention is to provide a reasoning criterion which includes at least one image and a language.

Still another object of the present invention is to provide a reasoning criterion capable of incorporating either real or virtual images or both.

Yet still another object of the present invention is to expose the potential consumer to the reasoning criterion.

It is yet another object of the present invention to provide a reasoning criterion illustrating the services offered by the provider while simultaneously educating the potential consumer about the service provider's articulated field of endeavor.

Still another object of the present invention is to encourage the potential consumer to deductively evaluate the reasoning criterion.

Yet still another object of the present invention is to provide a method of establishing a commercial relationship wherein the intercommunication between the potential consumer and the service provider is face to face.

It is yet another object of the present invention to provide a method of establishing a commercial relationship wherein the intercommunication between the potential consumer and the service provider is not face to face.

Yet another object of the present invention is to openly encourage the potential consumer to logically evaluate the reasoning criterion while tacitly suggesting the potential consumer utilize the provider's services.

It is yet another object of the present invention to provide a method of intercommunication where, after exposure to the reasoning criterion, the potential consumer will logically deduce to utilize the provider's services.

Still another object of the present invention is to provide a method of establishing the commercial relationship between the potential consumer where the communication channel can be opened by either the service provider or the potential consumer.

Yet still another object of the present invention is to provide a method of establishing a commercial relationship between the potential consumer and the service provider that incorporates the Registered Trademark or Service Mark of the service provider.

It is yet another object of the present invention to provide a method of establishing a commercial relationship between the potential consumer and the service provider which incorporates preselected words of the Registered Trademark or Service Mark into the language of the method.

Still another object of the present invention is to provide a communication channel wherein the potential consumer requests the service provider to articulate the reasoning criterion.

Yet still another object of the present invention is to provide a communication channel wherein the service provider invites inquiry from the potential consumer regarding a stimulus initiated by the articulation of the present method.

Yet another object of the present invention is to provide a method of establishing a commercial relationship between the potential consumer and the service provider regardless of the nature of services offered by the provider.

Yet still another object of the present invention is to provide a method of establishing a commercial relationship between the potential consumer of legal services and the provider of legal services.

It is yet another object of the present invention to provide a method of establishing a commercial relationship between the potential consumer of legal services related to intellectual properties and the provider of intellectual property legal services.

Yet still another object of the present invention is to incorporate a professional paradigm into the present method, wherein the paradigm models the manner in which the service provider renders service.

Yet another object of the present invention is to provide a method of establishing a commercial relationship between the service provider and the potential consumer of the service which includes a bi-directional intercommunication utilizing real and/or virtual images intermixed, intermingled and/or blended with language.

It is yet another object of the present invention to provide a method of manually advertising or otherwise displaying a message in a public place that incorporates a unique headdress.

Yet still another object of the present invention is to provide a method of electronically or otherwise displaying a message in a public place that incorporates a unique headdress.

Yet another object of the present invention is to provide a method of electronically or otherwise displaying a message in a public place that can incorporate a unique headdress having at least five message boards.

An embodiment of the present method can be described as a method of establishing a commercial relationship between a service provider and a consumer of the service where the intercommunication between the potential consumer and the service provider includes a reasoning criterion articulating a language and at least one image, wherein the method comprises the steps of: opening a communication channel between said service provider and said potential consumer wherein said intercommunication is bi-directional and face-to-face; articulating said reasoning criterion originated by said service provider; and encouraging said potential consumer to evaluate said reasoning criterion, before utilizing said service provider's services.

Another embodiment of the present method can be described as a method of establishing a commercial relationship between a service provider and a consumer of the service where the intercommunication between the potential consumer and the service provider includes a reasoning criterion articulating a language and at least one real image, wherein the method comprises the steps of: opening a communication channel between said service provider and said potential consumer by said potential consumer wherein said intercommunication is electronically bi-directional; articulating said reasoning criterion originated by said service provider; and encouraging said potential consumer to evaluate said reasoning criterion, before utilizing said service provider's services.

Yet another embodiment of the present invention can be described as a method of displaying a message in a public place wherein the method comprises the steps of: arranging for payment from an advertiser prior to wearing a headdress; wearing a brimless visorless headdress including a message board displaying a message; exposing said message board displaying said message in a public place; and moving said message board about said public place.

It is the novel and unique interaction of these simple elements which creates the methods, within the ambit of the present invention. Pursuant to Title 35 of the United States Code, descriptions of preferred embodiments follow. However, it is to be understood that the best mode descriptions do not limit the scope of the present invention.

### BRIEF DESCRIPTION OF THE DRAWINGS

In accordance with the present invention, FIG. 1 is portrayal of a World Wide Web home page.

FIG. 2 is a representation of a professional paradigm, within the scope of the present invention.

FIG. 3 is a continuation of the professional paradigm of FIG. 2.

In accordance with the present method, FIG. 4 is a depiction of a reasoning criterion.

FIG. 5 is a continuation of the exemplification of the above identified reasoning criterion.

FIG. 6 is a further continuation of the above identified reasoning criterion.

FIG. 7 is an illustration of the steps of an embodiment of the present method.

FIG. 8 is a depiction of the steps of another embodiment of the present invention.

FIG. 9 is an exemplification of the steps of yet another embodiment of the current method.

FIG. 10 is a diagrammatic representation of the steps of still another embodiment of the present invention.

FIG. 11 is a schema of the steps of yet still another embodiment of the present method.

Within the scope of the present invention, FIG. 12 is a representation of a verbal articulation of the reasoning criterion.

FIG. 13 is a side view perspective of a headdress utilized in a manual method of publicly displaying a message.

FIG. 14 is a top side view perspective of a headdress associated with an electronic method of publicly displaying a message.

FIG. 15 is a top side view perspective of a cubic headdress having five distinct message electronic message boards associated with the method of publicly displaying a message or an advertising message.

FIG. 16 is a depiction of the steps of the present method for face-to-face advertising or otherwise displaying a message in a public place.

### DESCRIPTION OF THE PREFERRED EMBODIMENTS

Although the disclosure hereof is detailed to enable those skilled in the art to practice the invention, the embodiments published herein merely exemplify the present invention.

FIG. 1 is a representation of the home page for the Counseling The Creative ® Web Site. It is seen that Counseling The Creative ® is a Registered Service Mark. Specifically, in this embodiment, the Service Mark Registration is granted for “legal services related to intellectual property,” but other embodiments of the present method of establishing a commercial relationship between a service provider and a potential consumer of the service can easily integrate and accommodate other Registered Trademarks/Service Marks.

Viewers of the Counseling The Creative ® Web Site readily comprehend it is highly dedicated to intellectual property matters. However, those skilled in the art will recognize the present method of establishing a commercial relationship between a service provider and a potential consumer of the service can be utilized by any type of service provider, from abbots and athletes to zaptiahs. Additionally and as is customary for the Web Site arts, FIG. 1 reveals the Site can further link the potential consumer to a plethora of legal information related to intellectual properties, as well as the descriptions of the services offered by the provider.

Whether through World Wide Web search engines, advertisement or word of mouth, use of a World Wide Web embodiment of the present method requires the potential consumer to open the communication channel. As shown in FIG. 1, by using the Web Site's electronic mail capacity, from almost anywhere, the potential consumer can establish a bi-directional intercommunication channel with the service provider. Such intercommunications are in real time, regardless of time zone differentials. FIG. 1 also reveals that the commercial relationship as well as the bi-directional intercommunication channel between potential consumer and service provider can be established by means other than electronic mail. For example, depending upon the preferences of the potential consumer and the service provider, in-person, common carrier, postal, telephonic and/or other electronic overtures can be employed to establish as well as continue the commercial relationship between the consumer and the service provider.

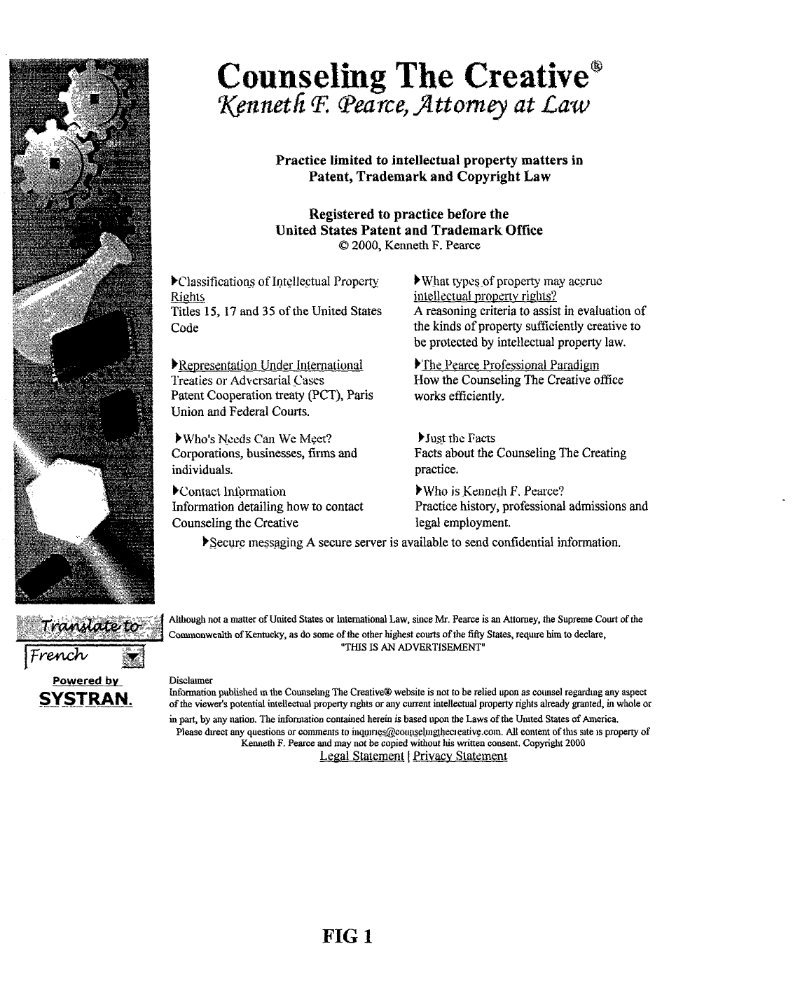

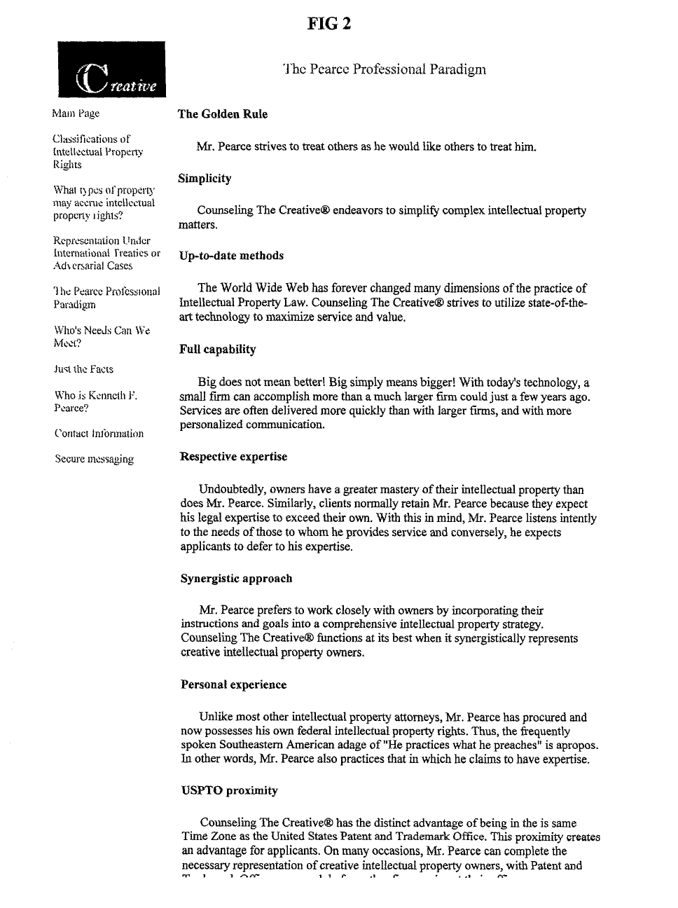

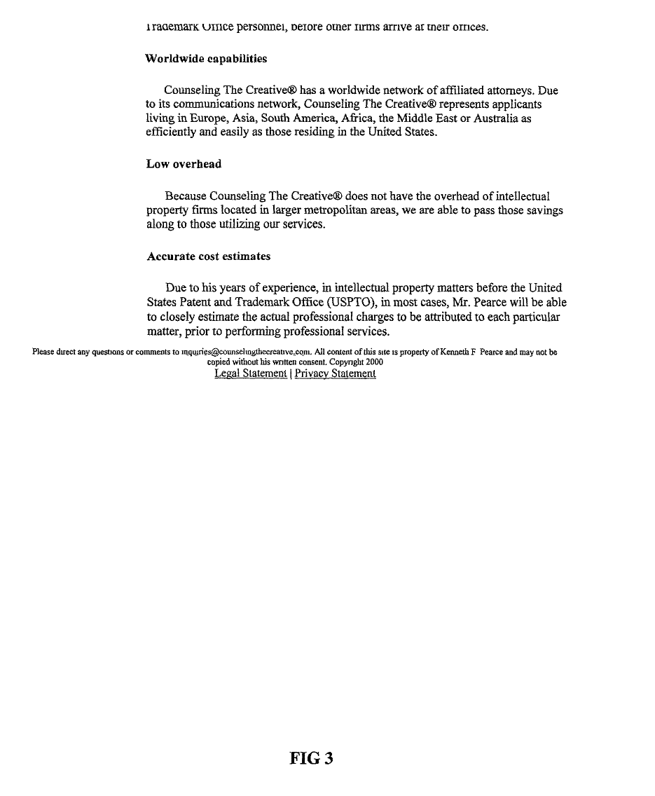

Looking at FIGS. 2 and 3, in accordance with the present invention, a professional paradigm is depicted. The paradigm furnishes an advance notice model of how the provider will render services to the potential consumer. And as with other pages of the Counseling The Creative ® Web Site, the professional paradigm is educational, instructional, as well as illustrative.

Returning to FIG. 1, along with the electronic mail nexus, the Counseling The Creative ® Web Site includes several informational/educational categories, including links to the previously identified professional paradigm, as well a reasoning criterion, within the ambit of present invention. The reasoning criterion specific to this embodiment is designated, “What types of property can accrue intellectual property rights?” Those skilled in the business arts comprehend that the cooperation between the reasoning criterion's identifying phraseology including its brief description thereunder and its location at a primary location of the Web Site, encourages the potential consumer to evaluate the reasoning criterion.

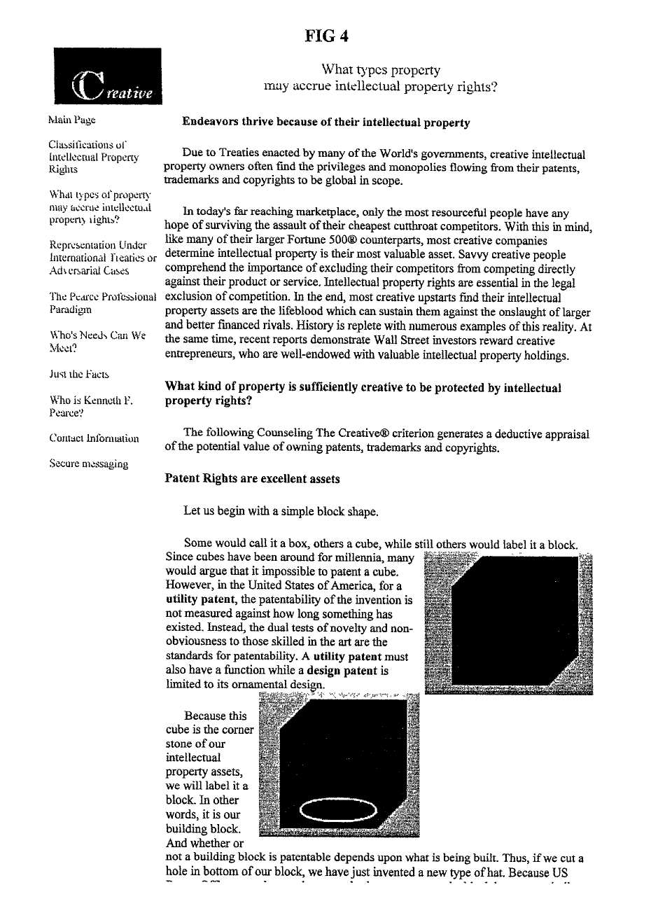

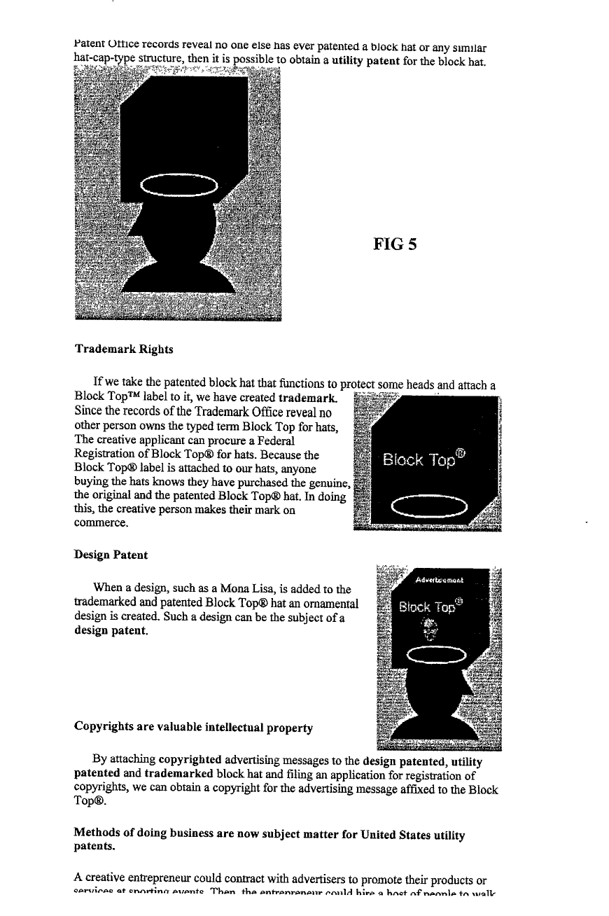

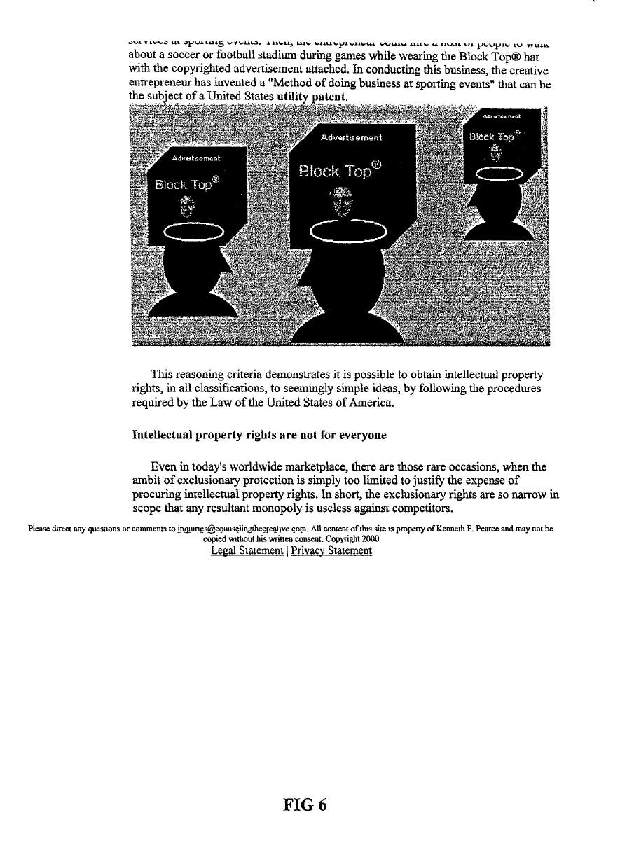

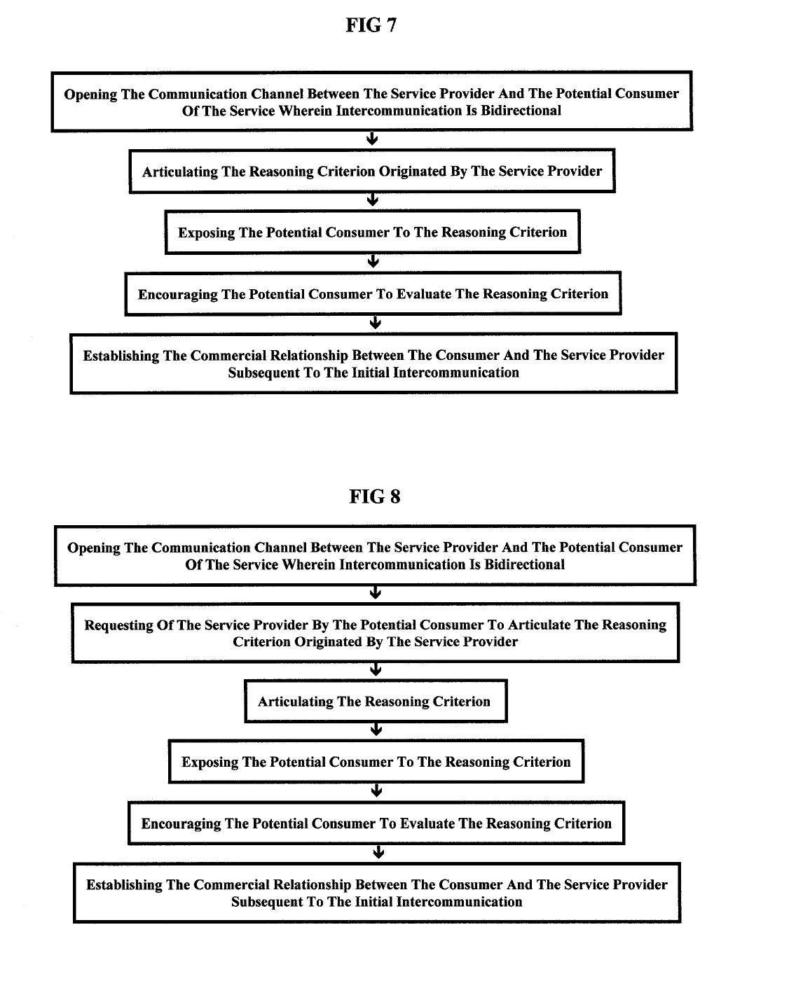

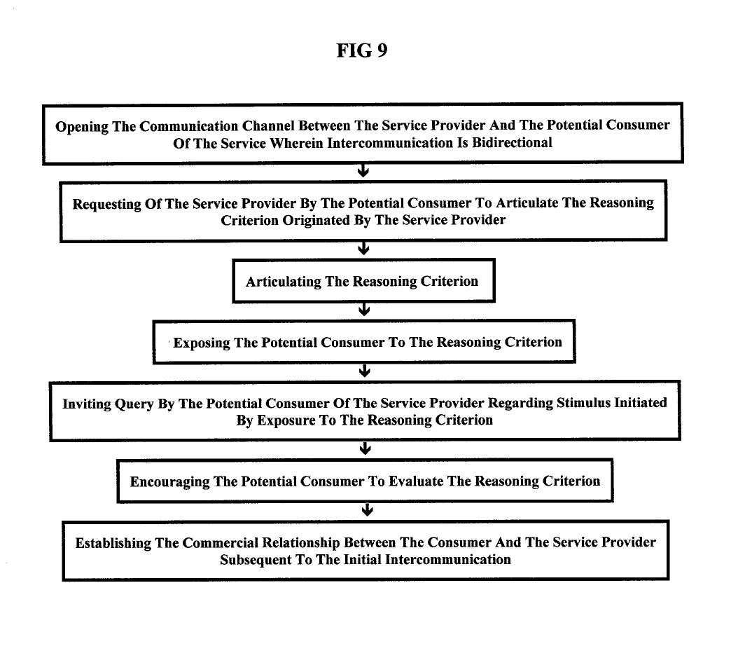

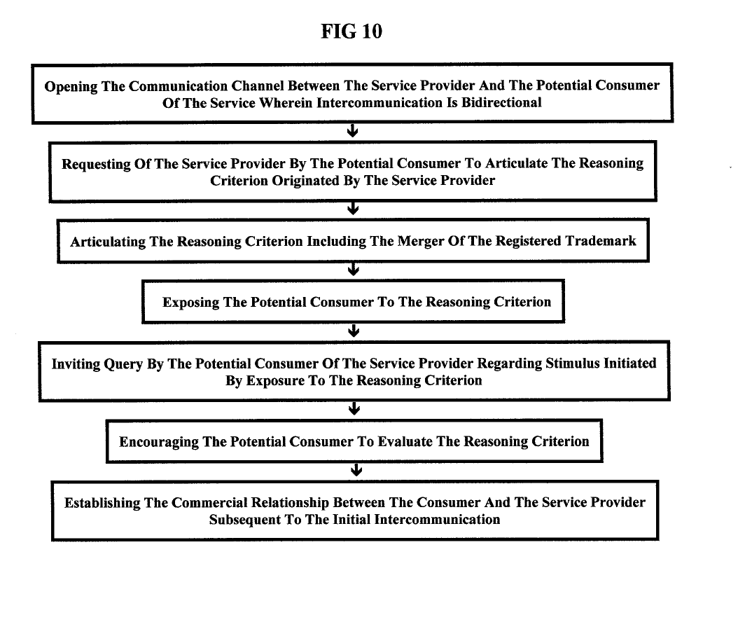

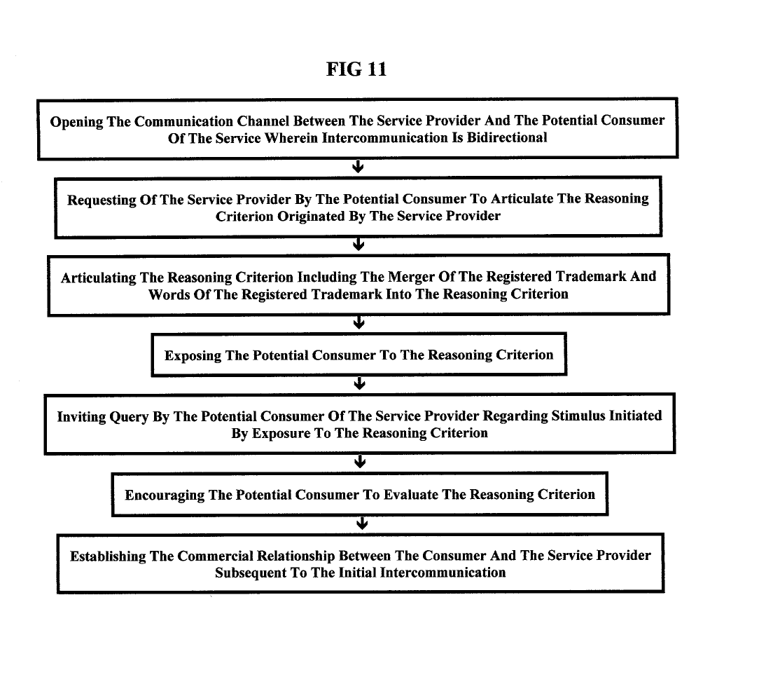

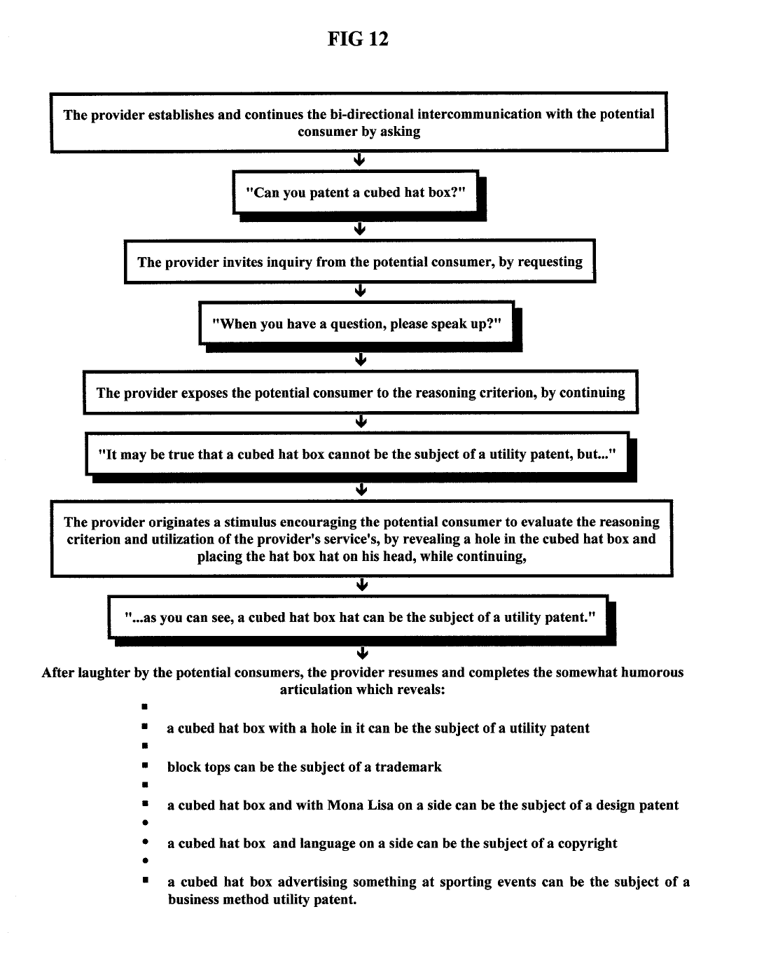

FIGS. 7-11 illustrate the steps of the present invention can include the blending of a Trademark/Service Mark and it parts into the language of the method. And as represented, in FIGS. 1-6, the merging or intermingling of the Registered Trademark/Service Mark and parts thereof with language is consistent on all the pages of the Counseling The Creative ® Web Site. In this manner, not only is the Trademark/Service Mark accentuated, the words comprising the Trademark/Service Mark are also innovatively elucidated in the practice of the present invention. Thus, in accordance with this particular best mode, incorporation of the service provider's Trademark/Service Marks also functions to uniquely mark the service provider as the source of the services upon either the conscious or the subconscious of the potential consumer, thereby tacitly suggesting the potential consumer utilize the service provider.

With a view still toward FIGS. 1-4, not only are the Registered Trademark/Service Mark and its parts included in the language of the Web Site, oftentimes, in syntax, those skilled in the grammatical arts recognize that the Registered Service Mark and its parts are used in the manufacture of sentences. Moreover, those skilled in the business arts comprehend the coupling of the provider's Registered Trademark/Service Mark and/or parts thereof with the language of the present method function to either usher the potential consumer toward or away from the provider's services. The potential consumer's deductive evaluation of the professional paradigm (FIGS. 2 and 3) and reasoning criterion (FIGS. 4-6), as well as the other pages of the provider's Web Site, function to segregate the staid from inconsequential potential consumers, thereby minimizing trivial overtures from potential clients toward the service provider. Exemplary methodologies of embodiments incorporating reasoning criterions are depicted in FIGS. 7-12.

For the Counseling The Creative ® embodiment implementing a Registered Service Mark, those skilled in the art comprehend that years of patient development, skill and planning were required to first procure a Registered Service Mark, without publicly displaying the present invention, until after the grant of the Service Mark and after the filing the present patent application. Only in this manner is it impossible for the inventor not incur the one year statutory bar against patentability mandated by the law of United States against public uses or offers for sale of the invention.

Within the ambit of the present method, reasoning criterions are originated by the service provider prior to the opening of the communication channel. As previously indicated, reasoning criterions, in accord with the present invention, among other things, articulate, illustrate, educate, suggest and inform. Moreover, reasoning criterions generate a stimulus for the potential consumer that encourages the potential consumer to reasonably evaluate the viability of using the service provider. And as earlier set forth above, the present method's reasoning criterions intermingle or blend images (real, virtual or both,) with the criterion's language. Thus, in accordance with the present invention, the various formats and styles of reasoning criterions are nearly infinite.

Observation of the Counseling The Creative ® reasoning criterion shown in FIGS. 4-6 reveals that a combination of language and universal or easily recognizable symbols are integrated and articulated therein. Within the scope of the present method, the images of reasoning criterion function pursuant to the simple adage of, “A picture is worth a thousand words.” Therefore, the images intermingled with the reasoning criterion can simplify the presentation of complex facts and information articulated to the potential consumer, thereby making the provider's services more consumer friendly.

In the particular embodiment disclosed in FIGS. 4-6, the universal symbols of solid blocks, blocks with apertures, holes or circles, Block Top ® hats, human profiles, registered trademark symbols and Mona Lisa are utilized. However, it is to be understood that depending upon the service provider's desires as well as the service provided, many other universal symbols can be easily incorporated into reasoning criterions to illustrate, illuminate and educate others about the services of the provider. By way of example, the pairings of language and universal symbols could include: accountants—ledgers, physicians—stethoscopes, plumbers—pipes, chefs—pastries, publishers—books, photographers cameras, and chauffeurs—limousines, just to denote a few of the many and virtually unlimited possibilities.

With a view still turned toward FIGS. 4-6, it is seen this specific reasoning criterion features a cube or building block as its centerpiece universal symbol. In combination with language and other universal symbols, the building block is used to exemplify different categories of intellectual properties. And as displayed in this particular embodiment, the universal block in combination with language is employed to illustrate:

block hats can be the subject of a utility patent;

block tops can be the subject of a trademark;

blocks hats with Mona Lisa on one side can be the subject of a design patent;

block hats with language on a side can be the subject of a copyright; and

block hats with advertising applied to their sides worn at sporting events can be the subject of a business method utility patent.

After exposure to the Counseling The Creative ® reasoning criterion, with or without linking to other pages of that Web Site, the potential consumer is provided with facts, information and knowledge to reasonably evaluate the viability of utilizing the provider's services. And, more likely than not, the potential consumer is encouraged to deductively evaluate the reasoning criterion. Thus, in this specific best mode, as exemplified in FIGS. 7-11, steps, in conformity with the present invention, have been employed.

Those skilled in the art comprehend World Wide Web enablements of the present invention exploit virtual images. Importantly, due to their global presence, it is believed that World Wide Web embodiments of the present invention will be preferred by the vast majority of the present method's users. It is also believed that both service providers and potential consumers will appreciate the convenience associated with the real time intercommunication capabilities of the current invention.

Although those skilled in the art recognize the usefulness of maintaining a global presence, face-to-face enablements of the method of establishing a commercial relationship between a service provider and a potential consumer of the service are also within the scope of the present invention. In the practice of the face-to-face embodiments, real or virtual images or both are intermingled with the present method. Articulation of either spoken or written language or combinations thereof in conjunction with the aforenoted images illuminates the reasoning criterion, thereby exposing the potential consumer to the reasoning criterion. Additionally, face-to-face methods may also employ electronic means, such as, microphones, television, radio, video or teleconferencing, to open, establish and maintain the bi-directional intercommunication channel.

Select face-to-face embodiments of the present invention are particularly well suited for opening the intercommunication channels associated with smaller numbers or smaller groups of potential consumers. Examples of such groups can include professional, fraternal, civic, social or religious gatherings. And those skilled in the art recognize that electronic means set forth above can assist the service provider in articulating the present method to proximate as well as remote groups. As used herein a group consists of at least one potential consumer or the potential consumer's representative and the service provider or the provider's representative.

Except for World Wide Web embodiments of the current invention, either the potential consumer or the service provider can open the bi-directional intercommunication channel. In other words, the potential consumer can request the service provider to articulate the method, or the service provider can request permission of potential consumer to articulate the present method. Thus, the bi-directional intercommunication channel can be opened by either the potential consumer or the service provider.

Steps associated with face-to-face embodiments are also depicted in FIGS. 7-12, and it shown that in practicing the present methods, the service provider or the representative of the service provider exposes the potential consumer to the reasoning criterion. Although different than World Wide Web utilization, the language and images of the reasoning criterions articulated by face-to-face embodiments are similar to the World Wide Web embodiments. For example, the steps, language and/or symbols disclosed in FIGS. 1-6 can also be incorporated into a face-to-face presentation or dialogue utilizing real images, such as block hats, advertising copy, so forth and so on.

As illustrated in FIGS. 7-12, the practice of the steps of a face-to-face embodiment including its accompanying reasoning criterion can comprise a verbal articulation by the provider. The spoken presentation intermingles images and language to expose the potential consumer to the reasoning criterion while simultaneously identifying aspects of intellectual property rights. Additionally and still within the scope of the face-to-face embodiments, real or virtual images or combinations thereof are employed and blended with the language of the present method. Thus, in association with real images, electronic virtual images can be simultaneously articulated to the group. For example, as the service provider verbally articulates the present method, virtual images of the provider's Trademark/Service Mark and parts thereof as well as other images can also be conveyed to the potential consumer. Further, a professional paradigm can also be incorporated into the face-to-face embodiments.

Because the intermingling or blending of language and images of present method is virtually unlimited, an abridged exemplification of a face-to-face verbal presentation is displayed in FIG. 12. In this particular best mode, a cubed hat box is employed as the reasoning criterion's universal image centerpiece. Thus, in this embodiment, a real cubed hat box has been substituted for the virtual building block universal centerpiece of a World Wide Web best mode set forth above. Importantly, the real cubed hat box has been originated in advance of the articulation to illustrate, educate and illuminate selected aspects of intellectual properties. Moreover, due to the service provider's application of the present invention, there is a tacit suggestion the potential consumer utilize the provider's services subsequent to the initial intercommunication.

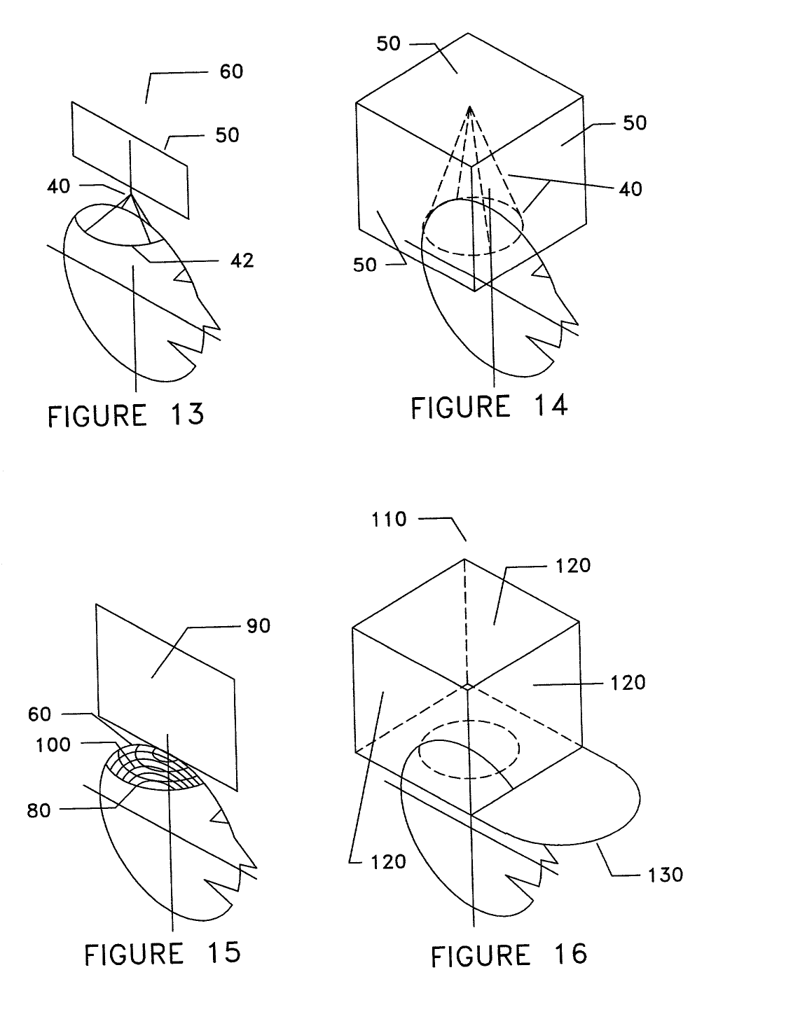

With a view toward FIG. 13, attention is directed to still another apparatus that can be used to practice the steps of yet another embodiment of the present invention. A headdress incorporating a manual embodiment of the present method is exemplified. Rest (40) supports message board (50) that is composed of any material capable of carrying the predetermined message. Further, message board (50) can have an identical or difference message on each of its sides.

Rest (40) can sit directly above the wearer's head, or rest (40) can sit above skullcap (42). Additionally, rest (40) can also be attached to skullcap (42). The combination of message board (50) and rest (40), or message board (50), rest (40) and skullcap (42) form headdress (60). As will be disclosed hereinafter, in other embodiments of the present invention, headdress (60) can also comprise other shapes that may firther include, among other things, brims or visors.

In accordance with this embodiment, more than a single message may be incorporated onto any message board (50). Importantly, those skilled in the adverting arts recognize that any predetermined message or messages can be applied to any preselected number of message boards (50). As shown in FIG. 14, rest (40) can be configured to support from one to five or more message boards (50). Thus, the message publicly exposed in accordance with the present method can be easily altered by manually changing the message board or boards (50) supported by rest (40). Select configurations of four message boards (50) can eliminate the necessity of utilizing rest (40).

In another embodiment of the present invention, as depicted in FIG. 15, electronic message board (90) is supported by rest (80). Rest (80) can also include covering (100) which can be composed of either sturdy or flexible material. Located underneath covering (100) and coupled to electronic message board (90) is controller (60). Electronic message board (90) publicly exposes the message or messages, as directed by controller (60). In one embodiment of the present method, controller (60) can be preprogrammed to deliver a predetermined message. However, in another embodiment of the present method, by way of illustration, controller (60) can receive a radio frequency signal, from a location remote to controller (60) for controlling the message publicly displayed by message board (90). Those skilled in the art understand controller (60) can easily alter the publicly exposed messages according to any predetermined pattern. For example, electronic message board (90) can display a ten second advertisement for services A, followed by a nine second advertisement for goods A, followed by eight second advertisement for goods B, so forth and so on.

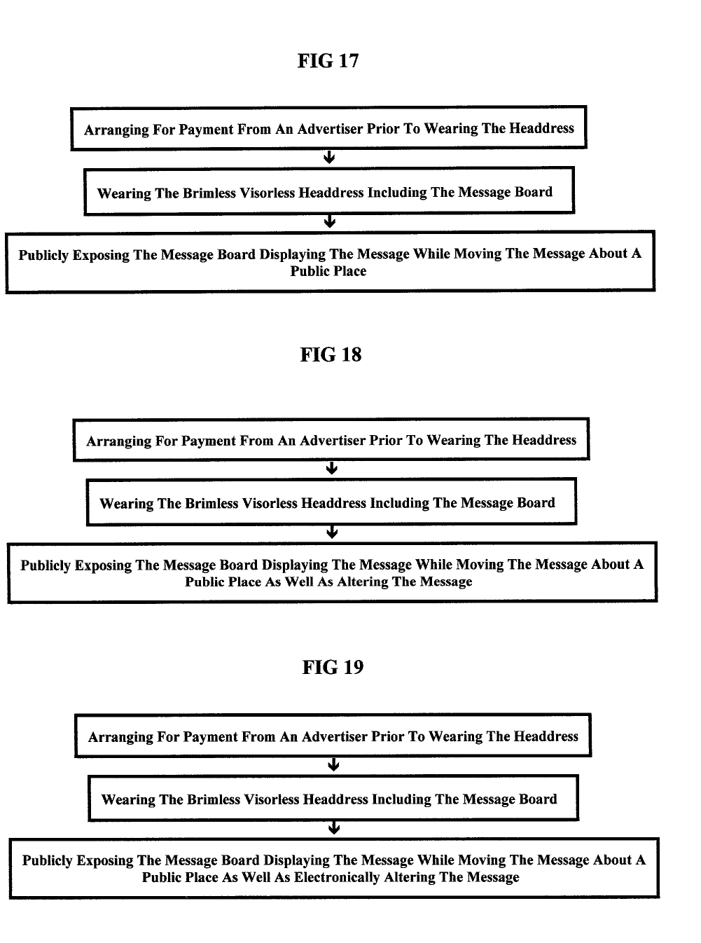

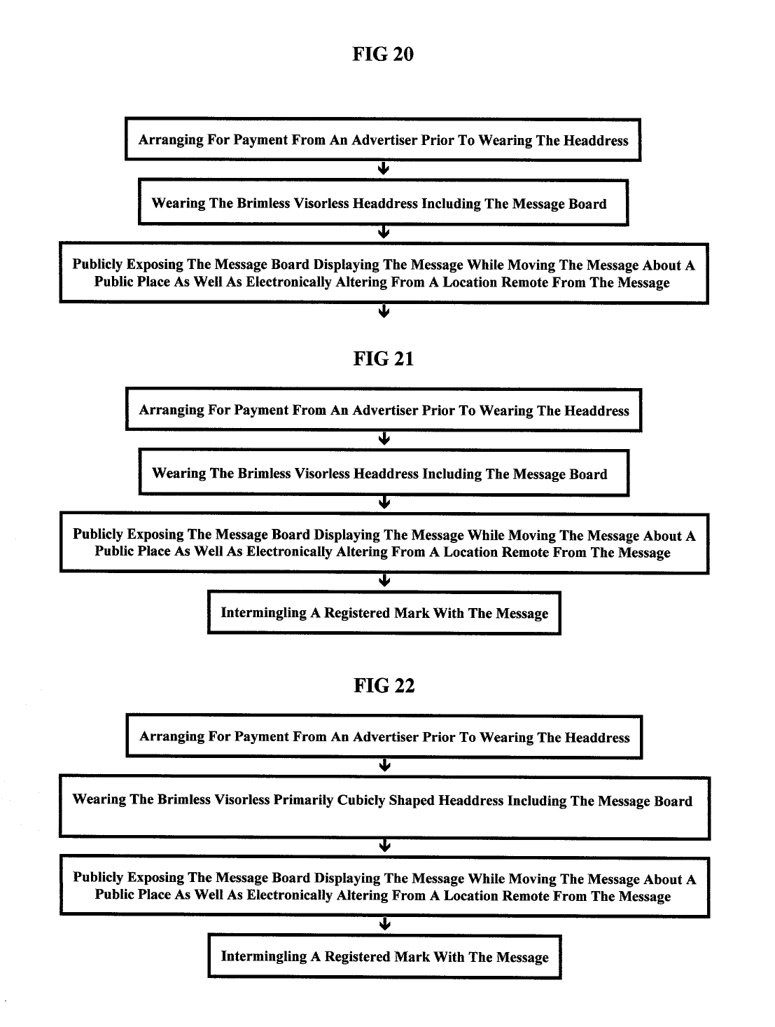

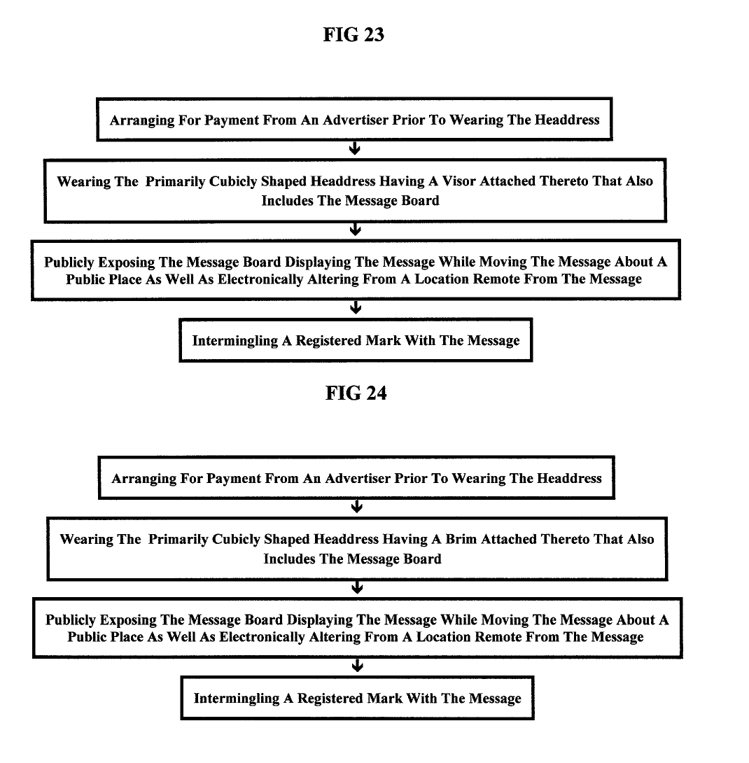

Looking at FIG. 16, in yet another embodiment of the present method, a cubic headdress (110) includes five distinct message boards (120). As directed by a controller (not shown), each message board (120) can publicly expose the same or different messages. Thus, by way of illustration, as the wearer of the headdress moves about at a sporting event, such as a professional football game, the angle of the viewer's perceptive field determines the advertising message or messages revealed publicly. As depicted in FIG. 16, a visor (130) is attached to headdress (110), but those skilled in the art recognize that a brim (not shown) also be attached to headdress (110). In FIGS. 17-24, the steps of a method for face-to-face advertising, including the wearing of a brimless visorless headdress, in a public place, are set forth. Examples of public places where this particular embodiment can be utilized, include, but are not limited to, sidewalks, streets, parks, office buildings, hotel lobbies, amusement centers, malls, shopping centers and sporting events. In short, this specific embodiment can be used in any public location where the wearer of the advertising or other message can move about.

Having disclosed the invention as required by Title 35 of the United States Code, Applicant now prays respectfully that Letters Patent be granted for his invention in accordance with the scope of the claims appended hereto.

What is claimed is:

1. A method of establishing a commercial relationship between a service provider and a consumer of said service provider's service wherein a face-to-face intercommunication between a potential consumer and said service provider includes a reasoning criterion articulating a language and at least one image; said method comprising the steps of:
a) opening a communication channel between said service provider and said potential consumer wherein said intercommunication is bi-directional and face-to-face;
b) articulating said reasoning criterion originated by said service provider; and
c) encouraging said potential consumer to evaluate said reasoning criterion, before utilizing said service provider's services.

2. The method of claim 1 wherein said potential consumer deductively evaluates said reasoning criterion.

3. The method of claim 2 further comprising the step of intermingling a plurality of real images into said language of said reasoning criterion.

4. The method of claim 3 further comprising the step of intermingling a plurality of virtual images into said language of said reasoning criterion.

5. The method of claim 4 further comprising the step of said potential consumer requesting articulation of said reasoning criterion.

6. The method of claim 5 further comprising the step of said service provider inviting query on a stimulus initiated by exposure of said potential consumer to said reasoning criterion.

7. The method of claim 6 wherein said commercial relationship between said consumer and said service provider is established subsequent to said intercommunication.

8. The method of claim 7 further comprising the step of merging a registered trademark into said language.

9. A method of establishing a commercial relationship between a service provider and a consumer of said service provider's service wherein an electronic intercommunication between a potential consumer and said service provider includes a reasoning criterion articulating a language and at least one image; said method comprising the steps of:
a) opening a communication channel between said service provider and said potential consumer by said potential consumer wherein said intercommunication is electronically bidirectional;
b) articulating said reasoning criterion originated by said service provider; and
c) encouraging said potential consumer to evaluate said reasoning criterion, before utilizing said service provider's services.

10. The method of claim 1 wherein said potential consumer deductively evaluates said reasoning criterion.

11. The method of claim 10 further comprising the step of intermingling a plurality of virtual images into said language of said reasoning criterion.

12. The method of claim 11 further comprising the step of said service provider inviting query on a stimulus initiated by exposure of said potential consumer to said reasoning criterion.

13. The method of claim 12 further comprising the step of merging a registered trademark into said language.

14. The method of claim 13 further comprising the step of intermingling a part of said registered trademark into said language.

15. The method of claim 14 further comprising the step of incorporating a professional paradigm into said intercommunication.

16. A method for face-to-face advertising comprising the steps of:
a) arranging for payment from an advertiser prior to wearing a headdress;
b) wearing a brimless visorless headdress including a message board displaying a message;
c) exposing said message board displaying said message in a public place; and
d) moving said message board about said public place.

17. The method of claim 16 further comprising the step of altering said message.

18. The method of claim 17 further comprising the step of using more than one message board.

19. The method of claim 18 further comprising the step of electronically altering said message.

20. The method of claim 19 further comprising the step of signaling an electronic alteration of said message from a location remote from said message board.

21. The method of claim 20 further comprising the step of intermingling a registered trademark into said message.

22. The method of claim 21 wherein external dimensions of said headdress are primarily cubical.

23. The method of claim 22 further comprising the step of attaching a visor to said headdress.

24. The method of claim 22 further comprising the step of attaching a brim to said headdress.
